(19) United States
(12) Patent Application Publication
(10) Pub. No.: US 2021/0284265 A1
(43) Pub. Date: Sep. 16, 2021

(54) SYSTEM AND METHOD FOR LOCKING A BICYCLE CHAIN

(71) Applicant: Daniel Otterstrom, Waite Park, MN (US)

(72) Inventor: Daniel Otterstrom, Waite Park, MN (US)

(21) Appl. No.: 17/178,774

(22) Filed: Feb. 18, 2021

Related U.S. Application Data
(60) Provisional application No. 62/990,000, filed on Mar. 16, 2020.

(51) Int. Cl. B62H 5/12; E05B 71/00

(52) U.S. Cl. CPC B62H 5/12; E05B 71/00

(57) ABSTRACT

A system and method for detachably locking an apparatus onto a bicycle chain to prevent rotation of the chain over the sprocket and thereby prevent theft of the bicycle.

### RELATED APPLICATION

This application claims the benefit of priority to U.S. Provisional Application No. 62/990,000 filed on Mar. 16, 2020.

### TECHNICAL FIELD

This disclosure relates to a lock that is secured to the chain of a bicycle to interfere with movement of the chain around the sprocket thereby preventing the propulsion of the bicycle forward using the bicycle crank.

### BACKGROUND

Bicycle theft is typically seen as a low police priority, its impact and magnitude often overlooked because police consider incidents on a case-by-case basis. This picture is often misleading, however, and when viewed at the aggregate level, bicycle theft represents a much larger problem, one with harmful economic and societal effects that warrant greater police attention.

The bicycle has become increasingly popular as a healthier and environmentally friendlier mode of transport. In London, for example, cycle use has increased by 83 percent between 2000 and 2007. In the United States, between 1992 and 2006, bicycle sales have increased from 15.3 million to 18.2 million per year (an increase of roughly 20%), illustrating an increase in cycle use there. While cycles enjoy the greatest share of transit options within campus towns, several major towns and cities such as Portland, Oreg., are continually improving cycling infrastructure to encourage cycling. Moreover, anticipating consumer demand, General Motors has developed the Flex-Fix system, a retractable bicycle rack that is hidden in a car's bumper. These changes in bicycle usage and provision have been influenced in recent years by:

increased awareness of the detrimental effect of automobile carbon dioxide emissions, and pursuit of air quality and emission reduction targets;

concerns over growing traffic congestion and accompanying noise pollution;

rising levels (and fear) of obesity and heart disease;

recognition that most trips are relatively short, or “bike-sized”;

savings in road maintenance and improvement of street infrastructure; and

responses to policies such as traffic congestion charging.

Several studies suggest that fear of cycle theft may discourage bicycle use, and that many bicycle theft victims do not buy a replacement. Combating bicycle theft is therefore a necessary step toward increasing the use of this sustainable form of transport, an increase that unexpectedly may also improve cyclist safety. To elaborate, a recent international review of schemes to encourage walking and cycling found strong evidence indicating that as the number of cyclists and walkers increased, the frequency of collisions between those groups and motorists decreased. The authors concluded that an effective means of improving the safety of cyclists and walkers is therefore to increase the numbers of people cycling and walking. Despite this, little attention has been paid to the prevention of bicycle theft. Car theft has received much more attention, for example, yet according to data collected as part of the International Crime Victim Survey, for all countries for which data were available (including the United States), bicycle owners are far more likely to have their bikes stolen (4.7%) than car owners their cars (1.2%) and motorcyclists their motorcycles (1.9%).

Understanding the problem of bicycle theft is hampered because police data typically underrepresent the problem. This is illustrated by data from the International Crime Victim Survey (2000), which show that across the 17 countries surveyed (including the United States), on average only 56 percent of bicycle thefts were reported to the police. U.S. crime statistics are collated using both National Crime Victim Survey (NCVS) data from a yearly national survey, and data recorded by the police. Comparing the two data sources highlights the problem of underreporting. For example, in 2004, bicycle theft accounted for 3.6 percent of all incidents of larceny (Federal Bureau of Investigation, 2005), which equates to more than 250,000 bicycles stolen each year. According to an estimate from the NCVS, in 2006 the number of incidents of theft-of or theft-from bicycles was more like 1.3 million (just under 2.5 incidents per minute). This suggests that for every crime reported, another four (or more) may have occurred.

Interviews with bicycle theft victims indicate that underreporting is largely due to victims' belief that the police are not interested in bicycle theft and cannot do anything about catching the offender and returning the stolen bicycle. A further reason for an underrepresentation of the problem is that police departments record bicycle theft in different ways that, however inadvertently, may serve to conceal the full scope of the problem. For example, police may record a bicycle theft as a burglary from a residential property.

Generally, when you come out and you find nothing but a busted lock where your bike used to be, the chances of being reunited with it are slim. Nationwide, less than half of stolen bicycles are recovered by police and barely 5 percent are reunited with their owners.

It is difficult to determine the precise number of stolen bicycles, because most bicycle theft is never reported to law enforcement. Over two million bicycles are stolen each year in the U.S. and Canada. Out of those, only 20 percent are ever reported to the police as stolen. The theft of two million bicycles was originally believed to be worth some $50 million, but now estimated to be a billion-dollar problem.

Another reason theft is so prevalent is that locks haven't kept pace with the times. The ones that do work can be so expensive or so heavy that they deter people from riding in the first place. GPS trackers can locate a stolen bike, but do nothing to stop thieves who only want to strip its parts.

### SUMMARY

In accordance with preferred embodiments of the device disclosed herein, some of the problems associated with bicycle locks are overcome.

In order to combat the increasing scourge of bicycle theft the apparatus disclosed herein repurposes the method of use of the invention under U.S. Pat. No. 3,624,945 titled Universal self-conforming trigger lock for firearms. The system and method for subverting the theft of bicycles requires the application of the locking mechanism disclosed herein to the chain of a bicycle. Once applied to the chain and locked in position onto the chain, the capacity to propel the bicycle using the locomotion hardware to include the pedals, sprockets and chain becomes extremely limited, if non-existent. Once the locking mechanism is applied to the chain, the chain cannot engage with the sprockets of the front carriage or the sprockets of the rear wheel cassette or navigate past the derailleur. Any attempt to force the locking mechanism around either the front carriage sprockets or the rear wheel cassette will result in either slippage of the chain off the sprocket, a seizing of the chain sprocket assembly in place and/or damage to the front and rear derailleurs.

These and other objects of the chain lock disclosed herein, which will become apparent hereinafter, are achieved by providing a lightweight and compact lock that secures to the chain of a bicycle preventing rotation of the chain around the sprocket due to interference between the lock and the sprockets and derailleurs.

It is therefore an object of the lock disclosed herein to be of sufficient mass to functionally inhibit normal operation of the bicycle by preventing rotation of the chain.

It is a further object of the lock disclosed herein to be fabricated from components that are sufficiently robust to prevent utilization of typical household tools to remove the lock from the chain.

These, together with other aspects of the lock disclosed herein, along with the various features of novelty that characterize the technology, are pointed out with particularity in the claims annexed hereto and form a part of this disclosed technology. For a better understanding of the disclosed technology, its operating advantages and the specific objects attained by its uses, reference should be made to the accompanying drawings and descriptive matter in which there are illustrated exemplary embodiments of the disclosed technology.

### BRIEF DESCRIPTION OF THE DRAWINGS

Illustrative embodiments of the lock disclosed herein are described in detail below with reference to the attached drawing figures, which are incorporated by reference herein and wherein:

FIG. 1 illustrates an elevation view of an embodiment of the locking apparatus;

FIG. 2 illustrates an embodiment of locking apparatus with a span of bicycle chain retained therein;

FIG. 3 is a view of embodiments of the inner faces of the first and second locking members;

FIG. 4; illustrates an assembly view of the locking apparatus;

FIG. 5; illustrates an embodiment of the striations upon both the shaft of the first locking member and the striated plate of the second locking member; and

FIG. 6 illustrates the opening extending through the second locking member is configured for receiving the cylinder therethrough.

### DETAILED DESCRIPTION

Disclosed herein are a system and method for preventing the theft of bicycles, and conceivably any chain driven apparatus, by the application of the locking device so disclosed and described.

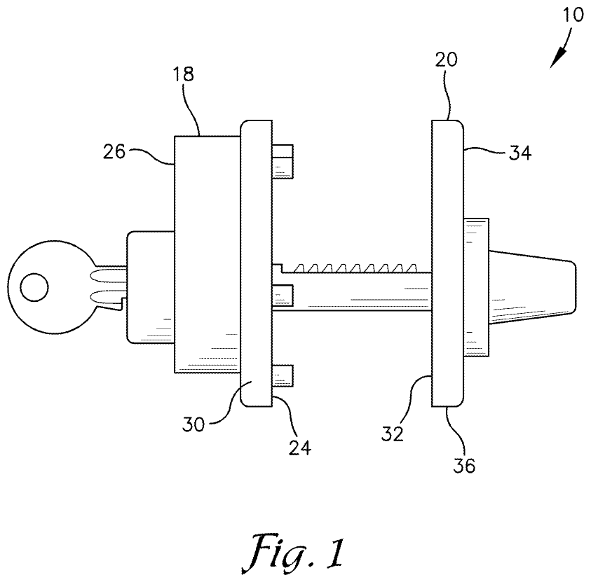

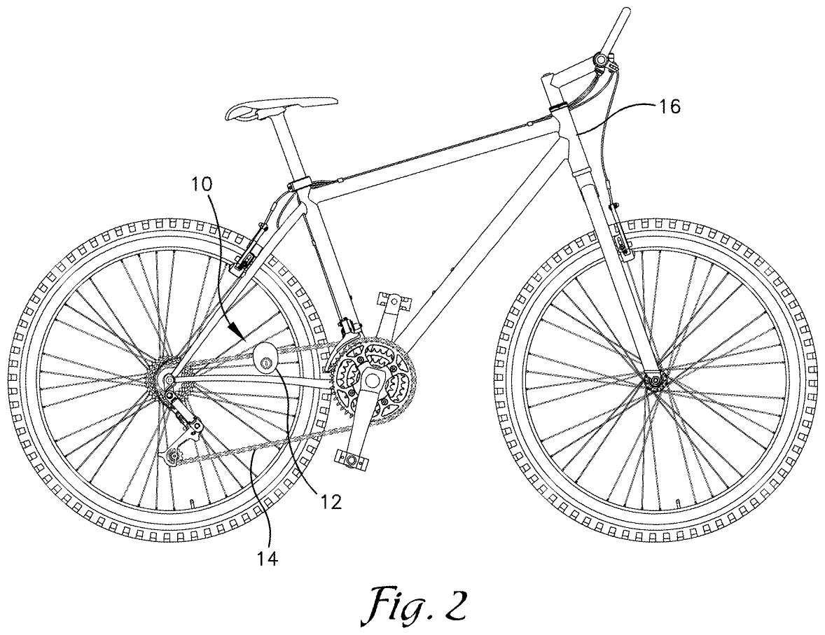

FIG. 1 illustrates a perspective view of the locking apparatus 10 in isolation. FIG. 2 illustrates the locking apparatus 10 as applied to a span 12 of chain 14 of a bicycle 16. Referring again to FIG. 1, the locking apparatus 10 is fabricated from first and second locking members 18, 20. The first locking member 18 has an inner face 24 and an outer face 26 as well as an outer perimeter surface 30. The second locking member 20 also has an inner face 32, and outer face 34 and a perimeter surface 36. The locking members 18, 20 are preferably fabricated from a material such as stainless steel that is capable of withstanding extreme environmental conditions without oxidizing and capable of withstanding the application of cutting forces from a saw or bolt cutter as well as capable of withstanding impact loads from a hammer.

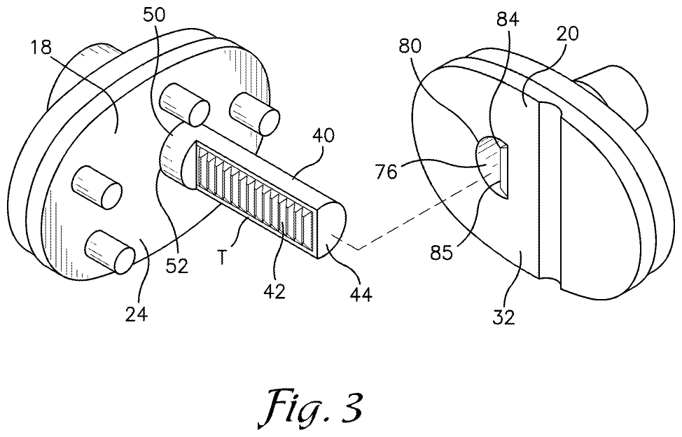

As illustrated at FIG. 3, a cylinder 40 extends outwardly from the first locking member 18. The cylinder 40 comprises a longitudinally extending open face, or cutaway 42. The arc of the cutaway 42 is preferably in the range of 110 to 160 degrees which facilitates engagement with another component that is described in detail below. The cylinder 40 preferably has a wall thickness T that provides sufficient strength to prevent undesirable bending when the locking apparatus 10 is placed under a heavy load, such as that applied by a thief attempting to liberate the bicycle from the rightful owner. The cylinder 40 also preferably utilizes a cap 44 that extends over most of the upper surface area of the cylinder 40. The base 50 of the cylinder 40 is preferably press-fit into an opening 52 in the inner face 24 of the first locking member 18. Once press into the opening 52, the cylinder 40 is securely maintained in position.

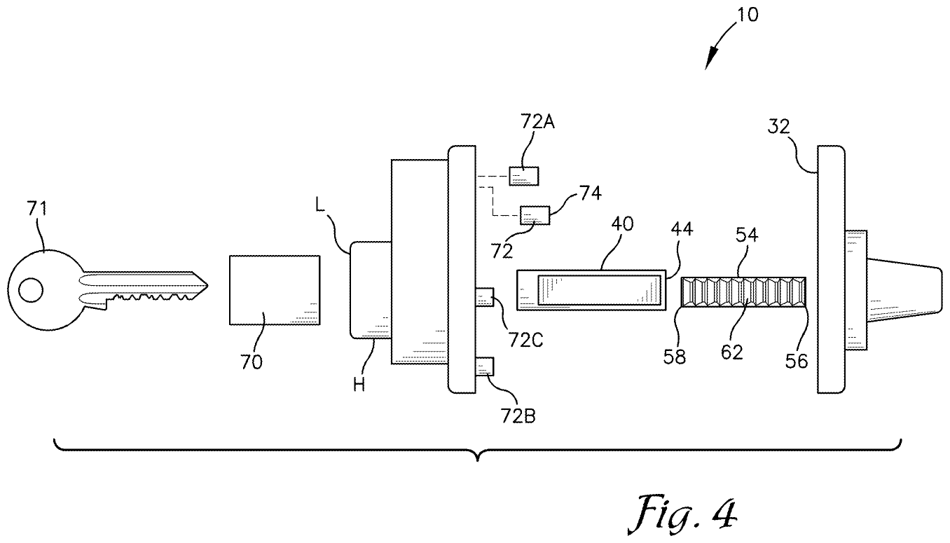

FIG. 4 illustrates an exploded assembly view of the locking apparatus 10 revealing the placement of a rotatable shaft 54 within the cylinder 40. The rotatable shaft 54 is observable from the open face 42 of the cylinder 40. The shaft 54 includes an upper end 56 and a lower end 58. The upper end 56 is disposed immediately beneath the cap 44 that extends over the cylinder 40. A portion of the total circumference of the shaft 54 from the upper end 56 to the lower end 58 includes striations 62. The striations 62 are preferably lateral cuts in the shaft 54 that are uniform and equally spaced along the entire length of the shaft. As seen in FIG. 5, each of the striations 62 also preferably include an overhang 66 that may be faced upwardly or downwardly but all striations on the shaft are uniform in direction of facing. Oppositely directed striations (up and down) facilitate the locking action that is necessary to prevent separation of the first and second locking members.

FIG. 4 reveals the locking mechanism 70 that is securely housed within a housing H that also includes an upper lip L. The housing H extends outwardly from the outer face 26 of the first locking member 18. The locking mechanism 70 protected within the housing H is operable to rotate the lower end 58 of the shaft 54. The locking mechanism 70 as well and the attachment structure between the locking mechanism and the shaft 54 are well known in the industry and are described with enabling disclosure in U.S. Pat. No. 3,624,945. The locking apparatus 10 preferably utilizes a key 71 to lock and unlock the locking mechanism 70. As with any standard lock found in many applications, the key 71 is rotated in one direction to lock the apparatus 10 and the opposite direction to unlock the apparatus.

Also illustrated at FIG. 4 is a spacer rod 72 with a distally located outer contact surface 74. The spacer rod 72 extends outwardly from the inner face 24 of the first locking member 18 and is preferably disposed proximate the cylinder 40. The preferred gap between the spacer rod 72 and the cylinder 40 is sufficient to position the span 12 of the bicycle chain 14 therein. The spacer rod 72 is preferably press fit into a predrilled hole in the inner face 24 of the first locking member 18. It is also contemplated by this disclosure that more than one spacer rod 72, 72A may be employed to provide enhanced robustness to the locking apparatus 10 thereby increasing the level of effort required by a thief to defeat the lock. In addition, supplemental spacer rods 72B, 72C may optionally be disposed on the opposite side of the cylinder 40.

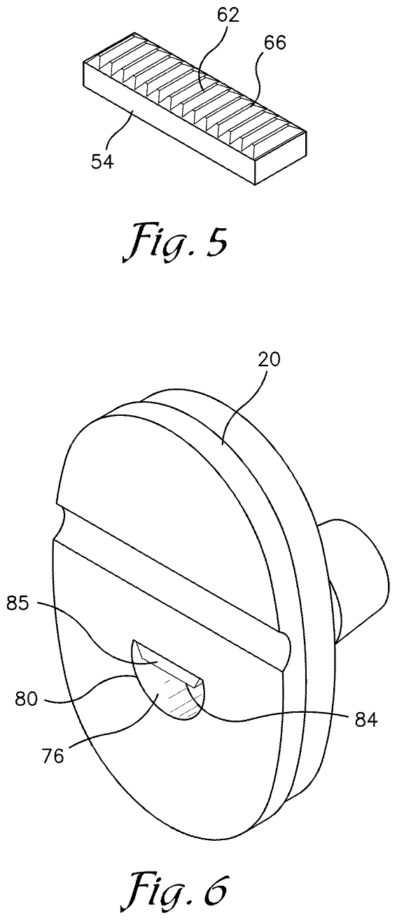

FIG. 6 illustrates an opening 76 extending through the second locking member 20 for passage therethrough of the cylinder 40. The opening 76 in the second locking member 20 includes an interior surface 80. Extending longitudinally along the interior surface 80 of the opening 76 is a striated plate 84. When the locking apparatus 10 is in operation the striated plate 84 is utilized for locking engagement with the striated surface of the shaft 54. The striations 85 on the plate 84 are oppositely directed from those of the striations 62 on the shaft 54. When the striations are oppositely directed from one another as they are on the shaft 54 and the striated plate 84 the striations can engage and interlock with one another so that the first and second locking members 18, 20 cannot be withdrawn from one another until the striations 62 on the shaft 54 are rotated away from the striations 85 on the striated plate 84.

In operation, the lock operator seeks to apply the locking apparatus 10 to a span 12 of chain 14 of a bicycle 16. The chain 14 for purposes of the apparatus disclosed herein circumscribes a front sprocket and a rear sprocket of the bicycle 16. The operator then places the span 12 of the bicycle chain 14 between the at least one spacer rod 72 and the outwardly extending cylinder 40. The cylinder and the spacer rod 40, 72 restrain the chain span 12 to movement along a linear path but do not fully restrain the chain span 12 thereby allowing the first and second locking members 18, 20 to complement restraint of the chain span 12 in position.

To fully enclose the chain span 12 between the first and second locking members 18, 20 the cylinder 40 is received into the opening 76 of the second locking member 20. As previously detailed above, the opening 76 in the second locking member 20 includes an interior surface 80. Extending longitudinally along the interior surface 80 of the opening 76 is a striated plate 84. As the cylinder 40 is advanced into the opening 76 of the second locking member 20, the striations 62 on the shaft 54 housed within the cylinder 40 may be rotated such that there is no contact between the shaft striations 62 and the striations on the plate 84. Lack of contact between the two striated surfaces occurs when the locking mechanism 70 is rotated away from the open face, or cutaway 42, effectively hiding the striations 62 from contact. Alternatively, the shaft striations 62 may remain within the open face 42 and the cylinder 40 may readily slide into the opening 76. Any attempt to withdraw the cylinder 40 is not be possible as the shaft striations 62 have engaged with the oppositely directed striations 85 of the striated plate 84.

Once the distally located outer contact surface 74 of the spacer rod 72 contacts the inner face 32 of the second locking member 20 the cylinder 40 and the enclosed shaft 54 are seated thereby fully restraining the chain span 12 in position between the first and second locking members 18, 20. Rotating the locking mechanism 70, with the key 71, rotates the shaft 54 housed within the cylinder 40 for interlocking engagement of the striations 62 upon the shaft 54 with the striations 85 upon the striation plate 84. This interlocking engagement of the two striated structures secures the span of chain 12 in position between the first and second locking members 18, 20 as well as between the cylinder 40 and the at least one spacer rod 72.

Any different arrangements of the various components depicted, as well as components not shown, are possible without departing from the spirit and scope of the disclosed technology. Embodiments of the disclosed technology have been described with the intent to be illustrative rather than restrictive. Alternative embodiments will become apparent to those skilled in the art that do not depart from its scope. A skilled artisan may develop alternative means of implementing the aforementioned improvements without departing from the scope of the disclosed technology.

It will be understood that certain features and sub combinations are of utility and may be employed without reference to other features and sub combinations and are contemplated within the scope of the claims. Not all steps listed in the various figures need be carried out in the specific order described.

I claim:

1. A method for releasably securing a lock onto a bicycle chain comprising the steps of:
providing a locking apparatus, the locking apparatus comprising:
(a) a first and second locking member, each locking member having an inner face and an outer face;
(b) a cylinder extending outwardly from the inner face of the first locking member, the cylinder comprising a longitudinally extending open face;
(c) a rotatable shaft disposed within the cylinder and observable from the open face, the shaft comprising an upper end and a lower end, a portion of the total circumference of the shaft from the upper end to the lower end striated;
(d) a locking mechanism housed within the first locking member, the locking mechanism operable to rotate the lower end of the shaft;
(e) at least one spacer rod with an outer contact surface, the at least one spacer rod extending outwardly from the inner face of the first locking member and disposed proximate the cylinder;
an opening extending through the second locking member for passage therethrough of the cylinder; and
(g) a striated plate extending longitudinally along at least a portion of the interior of the opening, the striated plate aligned for locking engagement with the striated surface of the shaft;
providing a bicycle chain that circumscribes a front sprocket and a rear sprocket of the bicycle;
placing a span of the bicycle chain between the at least one spacer rod and the outwardly extending cylinder;
receiving the cylinder into the opening of the second locking member;
advancing the cylinder into the opening of the second locking member until the outer contact surface of the at least one spacer rod contacts the inner face of the second locking member;
rotating the locking mechanism and shaft for interlocking engagement of the striations upon the shaft with the striations upon the striation plate thereby securing in position the span of chain between the first and second locking members as well as between the cylinder and the at least one spacer rod.

2. The method of claim 1, wherein the longitudinally extending open face of the cylinder comprises an angle in the range of about 110-160 degrees.

3. The method of claim 1, wherein the inner face of the second locking member includes a groove for positioning of the span of the bicycle chain.

4. The method of claim 1, wherein the at least one spacer rod is press fit into an opening in the first locking member.

5. The method of claim 1, wherein the locking mechanism is operable with a key.

6. The method of claim 5, wherein the key is removable by an operator of the locking apparatus.

7. The method of claim 1, wherein the locking mechanism is operable to rotate the shaft.

8. The method of claim 1, wherein a cylindrical housing resides on the outer face of the second locking member.

9. The method of claim 1, wherein the shaft translates longitudinally within the cylindrical housing.

10. The method of claim 1, wherein the striations on both the surface of the shaft and the striation plate are laterally disposed.

11. The method of claim 10, wherein the striations upon the surface of the shaft are directed oppositely to the striations upon the striation plate to facilitate interlocking engagement.

12. A system for releasably fastening a lock onto a bicycle chain, the system comprising:
a locking apparatus, the locking apparatus comprising:
(a) a first and second locking member, each locking member having an inner face and an outer face and a groove in at least one of the inner faces of the first and second locking members;
(b) a cylinder extending outwardly from the inner face of the first locking member, the cylinder comprising a longitudinally extending open face;
(c) a shaft rotatably disposed within the cylinder, the shaft further comprising an upper end and a lower end with striations partially circumscribing the shaft from the upper end to the lower end;
(d) a locking mechanism housed within the first locking member, the locking mechanism operable to rotate the shaft disposed within the cylinder;
(e) at least one spacer rod with a distally located contact surface, the at least one spacer rod extending outwardly from the inner face of the first locking member and disposed proximate the cylinder;
an opening with an interior surface, the opening extending through the second locking member for passage therethrough of the cylinder; and
(g) a striated plate extending longitudinally along at least a portion of the interior surface, the flat striated plate for interlocking engagement with the striations of the shaft;
a span of chain disposed between a front sprocket and a rear sprocket of the bicycle, wherein the span is positioned between the at least one spacer rod and the outwardly extending cylinder, wherein the cylinder is received into the opening of the second locking member until the outer contact surface of the at least one spacer rod contacts the inner face of the second locking member thereby capturing the span between the first and second locking member as well as between the cylinder and the at least one spacer rod, wherein rotation of the locking mechanism and the shaft connected thereto interlocks the striations upon the shaft with the striations upon the striated plate, thereby securing the span of chain in position within the locking apparatus.

13. The apparatus of claim 12, wherein the striations partially circumscribe the shaft from the upper end to the lower end and are substantially flat.

14. The apparatus of claim 12, wherein the striations on the striated plate are substantially flat for engagement with the substantially flat striations on the shaft.

15. The apparatus of claim 14, wherein the flat striations on the striated plate are canted oppositely those of the striations on the shaft to facilitate locking engagement between the plate and the shaft.

16. An apparatus for limiting motion of a bicycle chain around a front and rear sprocket, the apparatus comprising:
(a) a first and second locking member, each locking member having an inner face and an outer face, at least one of the inner face of the first and second locking members having a channel therein;
(b) a cylinder with a first end and a second end, the second end disposed distally from the inner face of the first locking member, the cylinder further comprising a longitudinally extending cutout;
(c) a shaft disposed within the cylinder, the shaft comprising an upper end and a lower end, the circumference from the upper end to the lower end partially striated and the shaft rotatable within the cylinder;
(d) a locking mechanism housed within the first locking member, the locking mechanism operable to rotate the shaft disposed within the cylinder;
(e) at least one spacer rod with an outer contact surface, the at least one spacer rod extending outwardly from the inner face of the first locking member and disposed proximate the cylinder, the outer contact surface configured for contact with the inner face of the second locking member when the locking apparatus is in a locked configuration;
(f) an opening with an interior surface, the opening extending through the second locking member for passage therethrough of the cylinder; and
(g) a striated plate extending longitudinally along and secured to the interior surface, the striated plate for locking engagement with the striated surface of the shaft, wherein
a span of chain disposed between a front sprocket and a rear sprocket of the bicycle is manually disposed within the channel and between the at least one spacer rod and the outwardly extending cylinder such that the cylinder is received into the opening of the second locking member until the outer contact surface of the at least one spacer rod contacts the inner face of the second locking member thereby capturing the span between the first and second locking members as well as between the cylinder and the at least one spacer rod, wherein an operator rotates the locking mechanism and the shaft connected thereto to engage the striations upon the shaft with the striations upon the flat striated plate, thereby lockingly securing the apparatus onto the chain.
